(19) United States
(12) Patent Application Publication
(10) Pub. No.: US 2003/0127563 A1
(43) Pub. Date: Jul. 10, 2003

(54) Differential pressure sensing release system

(76) Inventor: Richard J. LaConte, Black Diamond, WA (US)

Correspondence Address: RICHARD J. LACONTE, c/o HARPER ENGINEERING, 200 S TOBIN ST., RENTON, WA, 98055, US

(21) Appl. No.: 10/280,271

(22) Filed: Oct. 25, 2002

Related U.S. Application Data
(60) Provisional application No. 60/336,458, filed on Oct. 26, 2001.

(51) Int. Cl. B64C 1/00

(52) U.S. Cl. 244/129.1

(57) ABSTRACT

A differential pressure sensing release system and apparatus specifically adapted for use with an aircraft or spacecraft compartment panel. The apparatus utilizes a mechanism activated by a pressure differential acting on a diaphragm(s) to trigger a single latch bolt or series of latch bolts or other retention mechanisms, thereby releasing the panel. The apparatus thus provides a means of equalizing the pressure differential between adjacent compartments, eliminating potential damage due to forces created by the pressure differential.

### CROSS-REFERENCED TO RELATED APPLICATIONS

This application claims priority from the U.S. provisional application serial No. 60/336,458, filed Oct. 26, 2001.

### FIELD OF THE INVENTION

This invention relates to a differential pressure sensing release system particularly adapted for use in aircraft or spacecraft compartment panels.

### BACKGROUND OF THE INVENTION

For aircraft or any other vehicle operating with a pressurized vessel, as in a fuselage, that is divided into compartments, there is generally a requirement that, in the event of a breach in the outer hull of the vessel, an automatic means of equalizing the pressure differential between compartments must be provided to minimize stress induced damage to the structure of the vehicle. The previous method of equalizing this differential has provided doors or panels between compartments that open or blow out when a specific load or force is applied to the door or panel. Retention has been provided by spring clips, detent latches, break away stops or other mechanisms that release at the predetermined force. The problem created by this method is that each retention device must be configured to release at a force dependent upon the surface area of the door or panel. In the case of a door that must generally operate to provide or deny passage between compartments, this method is inadequate as a lockable retention system. In the case of a panel that must generally remain in place during any application of force other than the differential pressure, this method of retention is inadequate to deter deliberate or accidental release of the panel.

### BRIEF SUMMARY OF THE INVENTION

The differential pressure sensing release system of this invention is a mechanism that is installed either on or within a door or panel and is activated when a pressure differential occurs across the door or panel. This triggers the release of a single latch bolt or multiple latch bolts or other retention mechanisms, thereby releasing the door or panel.

The trigger link is configured to be either linear, rotary, or any other directional linkage or combination thereof. Release energy is obtained through springs, other energy storage devices, or incorporation of self-energizing linkages. The advantage of this system is that the door or panel may be positively restrained in position against large magnitude forces, while being released automatically in the case of a pressure differential of relatively low magnitude.

In one form, the preferred embodiment of the differential pressure sensing mechanism generally comprises a housing, a bolt, a trigger link, a detent, and multiple pressure sensing diaphragms. The direction of the diaphragm movement is positioned 90 degrees to the bolt restraining direction. This configuration eliminates the possibility of unintended release due to impact inertia forces acting on the mechanism. This form also utilizes the use of multiple metal diaphragms that allows a housing of minimal thickness for a given diaphragm area. In addition, a bearing and its support is located between the escapement piston and the detent to reduce friction acting on the system.

Further areas of applicability of the present invention become apparent from the detailed description provided. The detailed description and specific examples of the general and preferred embodiments are intended for illustration purposes and are not intended to limit the scope of the invention.

### BRIEF DESCRIPTION OF THE DRAWINGS

FIG. 1 is a perspective view of a panel mounted linear single bolt differential pressure sensing release system.

FIG. 2 is a perspective view of a panel mounted rotary multiple bolt differential pressure sensing release system.

FIG. 3 is a perspective view of a door mounted linear door latch differential pressure sensing release system.

FIG. 4 is an elevation view of a linear operating differential pressure sensing release mechanism.

FIG. 5 is an elevation view of a rotary operating differential pressure sensing release Mechanism.

FIG. 6 is a section view of the differential pressure sensing release mechanism.

FIG. 7 is a section view of the differential pressure sensing release mechanism in transition due to a pressure differential.

FIG. 8 is a section view of the differential pressure sensing release mechanism in a fully activated position due to a pressure differential.

FIG. 9 is an elevation view of a linear differential pressure sensing release system with a rotary bolt in a latched position.

FIG. 10 is an elevation view of a linear differential pressure sensing release system with a rotary bolt in an activated position.

FIG. 11 is an elevation view of a rotary differential pressure sensing release system with a linear bolt in a latched position

FIG. 12 is an elevation view of a rotary differential pressure sensing release system with a linear bolt in an activated position

FIG. 13 is an elevation view of a linear differential pressure sensing release system with a linear latching bolt in a latched position.

FIG. 14 is an elevation view of a linear differential pressure sensing release system with a linear latching bolt in a latched position.

FIG. 15 is an elevation view of the preferred embodiment containing enhanced features

### DETAILED DESCRIPTION

The following detailed description of the differential pressure sensing release system invention is described following the order of figures, wherein;

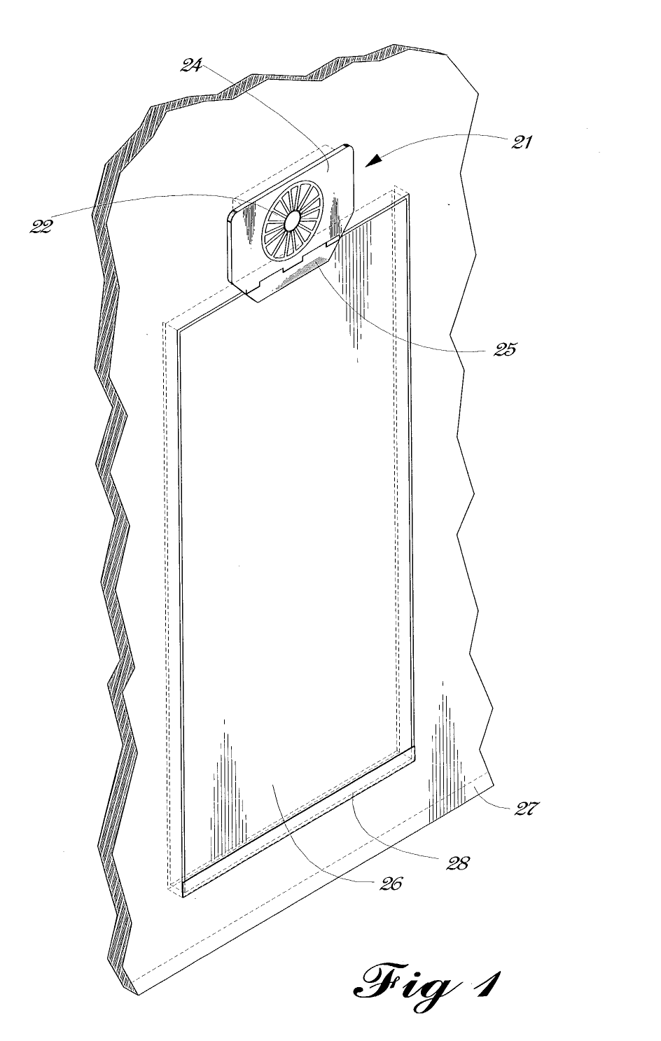

FIG. 1 shows a linear differential pressure sensing release system 21 made up of a linear differential pressure sensing release mechanism 22 in a latch housing 24 containing and operating a bolt 25. It is mounted in a door 26 and restrains a panel 27 that is trapped by a channel 28.

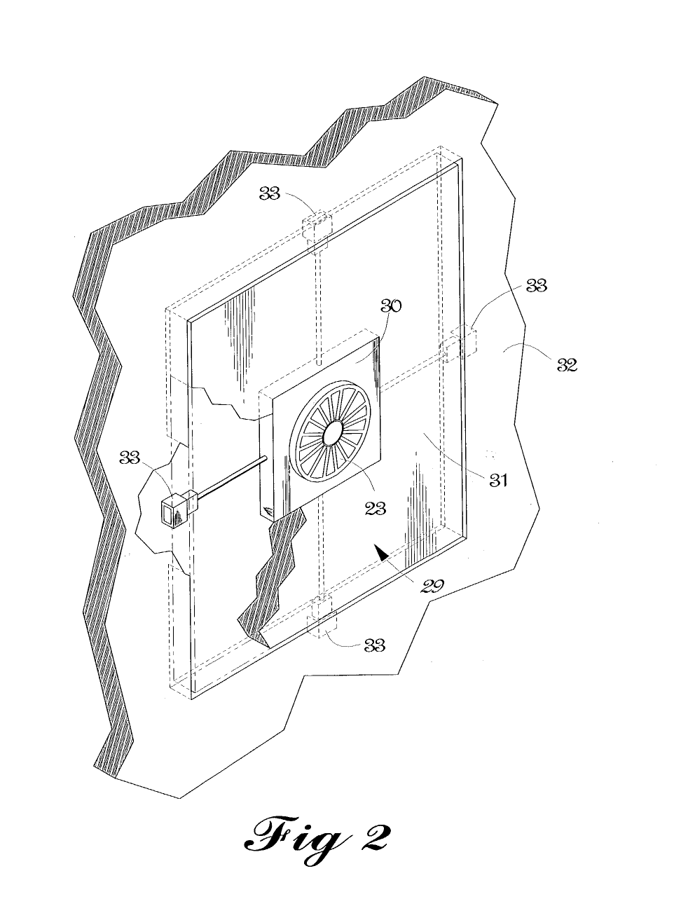

FIG. 2 shows a rotary/linear differential pressure sensing release system 29 made up of a rotary differential pressure sensing release mechanism 23 in a latch housing 30. It is mounted in a panel 31 that is retained in compartment structure 32 by multiple linear bolts 33.

FIG. 3 shows a linear differential pressure sensing release system 34 made up of a linear differential pressure sensing release mechanism 22 in a latch housing 35 operated by a knob type handle 36. It is mounted in a door 37 that is attached with a hinge 39 to compartment structure 38 and is retained by a latch bolt 40.

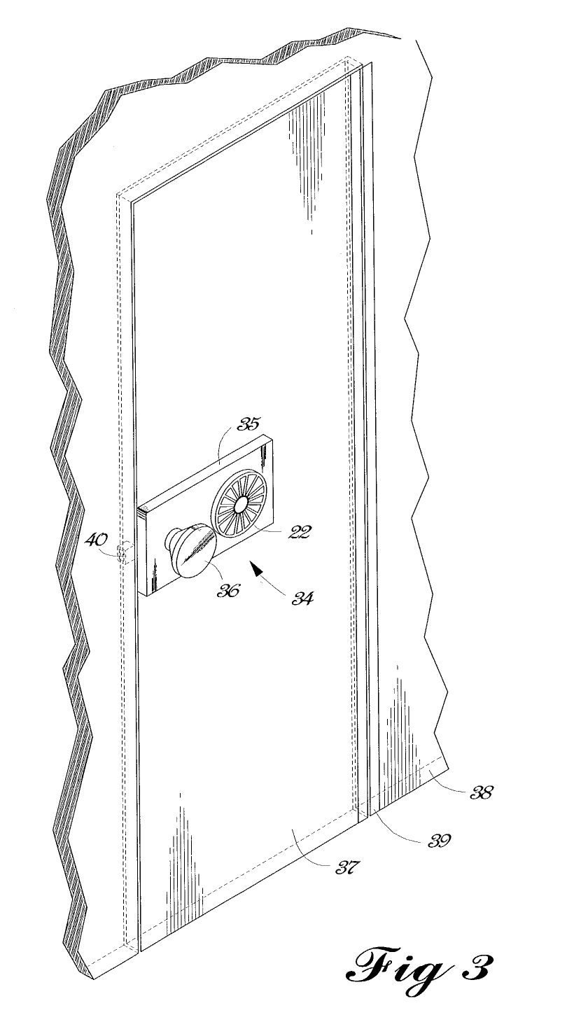

FIG. 4 shows a linear differential pressure sensing mechanism 22 made up of a differential pressure sensing assembly 41 retaining a linear trigger link 42 with detents 43.

FIG. 5 shows a rotary differential pressure sensing mechanism 23 made up of a differential pressure sensing assembly 41 retaining a rotary trigger link 44 with detents 43.

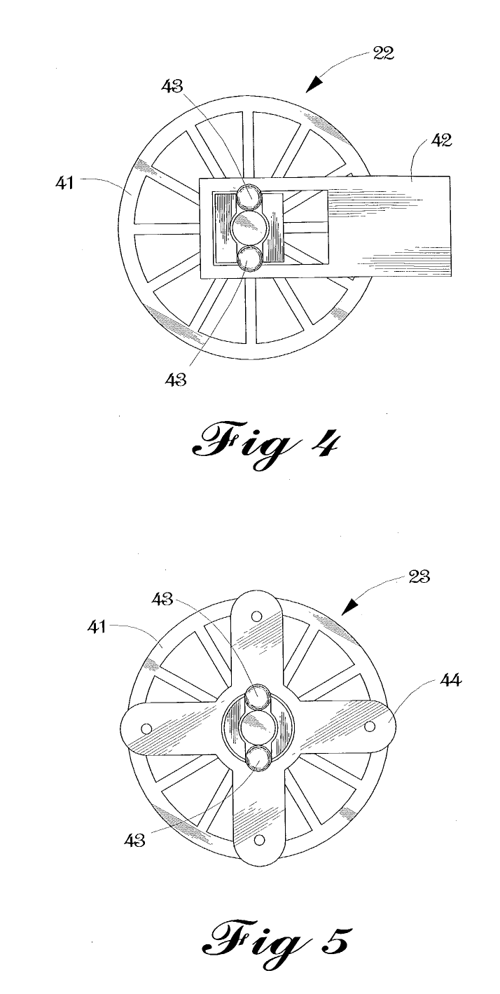

FIG. 6 shows a differential pressure sensing release assembly 41 made up of a vented detent guide frame 45 and a vented rod guide frame 46 containing a diaphragm 47 with an attached actuator rod 48 and escapement piston 49 and one or more detents 43

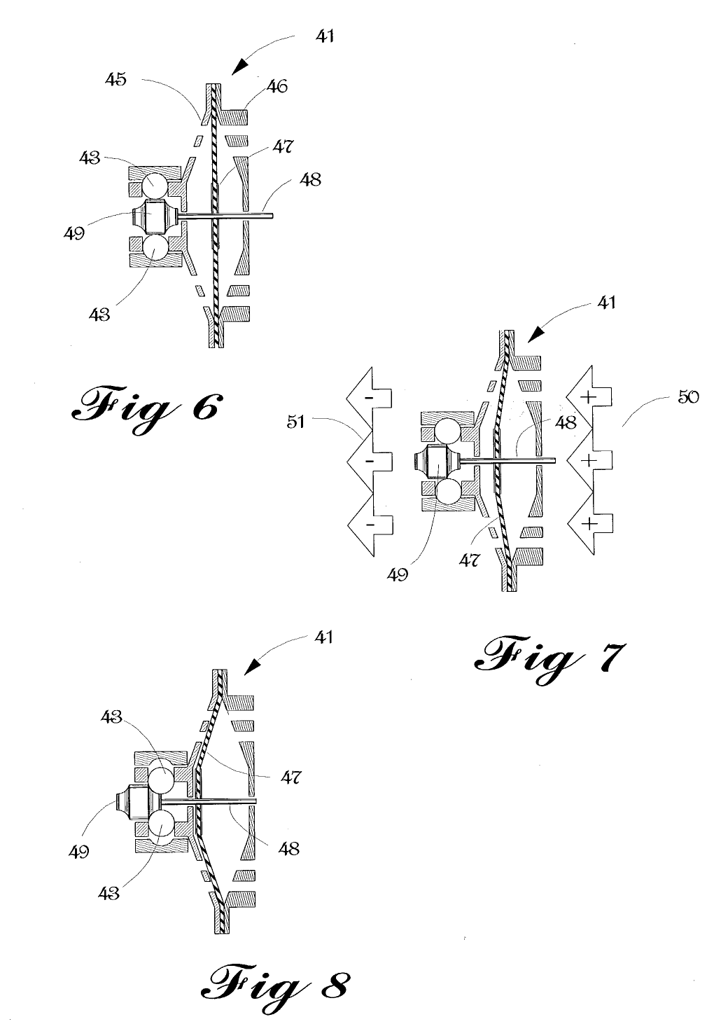

FIG. 7 shows the differential pressure sensing assembly 41 of FIG. 6 in transition due to a pressure differential between a high-pressure volume 50 and a low-pressure volume 51 deflecting the diaphragm 47, actuator rod 48 and escapement piston 49 toward the low-pressure side of the pressure sensing assembly 41.

FIG. 8 shows the differential pressure sensing assembly 41 of FIG. 6 fully activated with the bearing balls 43 deflected into the escapement piston 49 recesses due to the diaphragm 47, actuator rod 48 and escapement piston 49 being fully deflected.

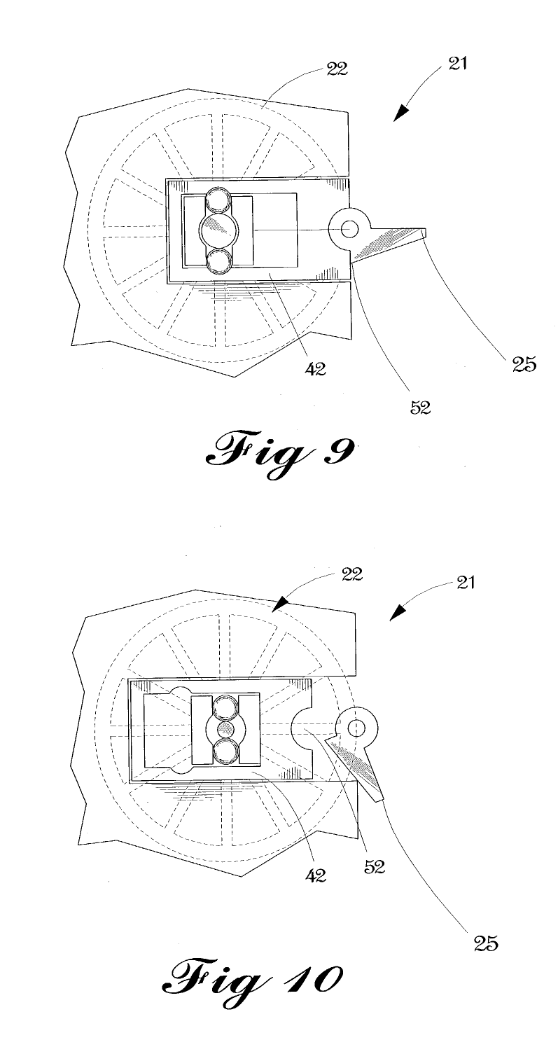

FIG. 9 shows a linear differential pressure sensing release system 22 with a rotary bolt in the latched position with the linear differential pressure sensing mechanism 22 with its linear trigger link 42 holding a rotary bolt 25 in the latched position against a pawl 52.

FIG. 10 shows the linear/rotary differential pressure sensing release system 22 of FIG. 9 in the activated position where the linear differential pressure sensing mechanism 22 has released the linear trigger link 42 that is restraining the pawl 58 allowing the bolt 25 to rotate to an unlatched position.

FIG. 11 shows a rotary differential pressure sensing release system 29 with a linear bolt(s) in the latched position with the rotary differential pressure sensing mechanism 23 with its rotary trigger link 44 connected by a rod link 54 and bolt 33 holding an energy storage device 53 in the stored position against a latch housing 55.

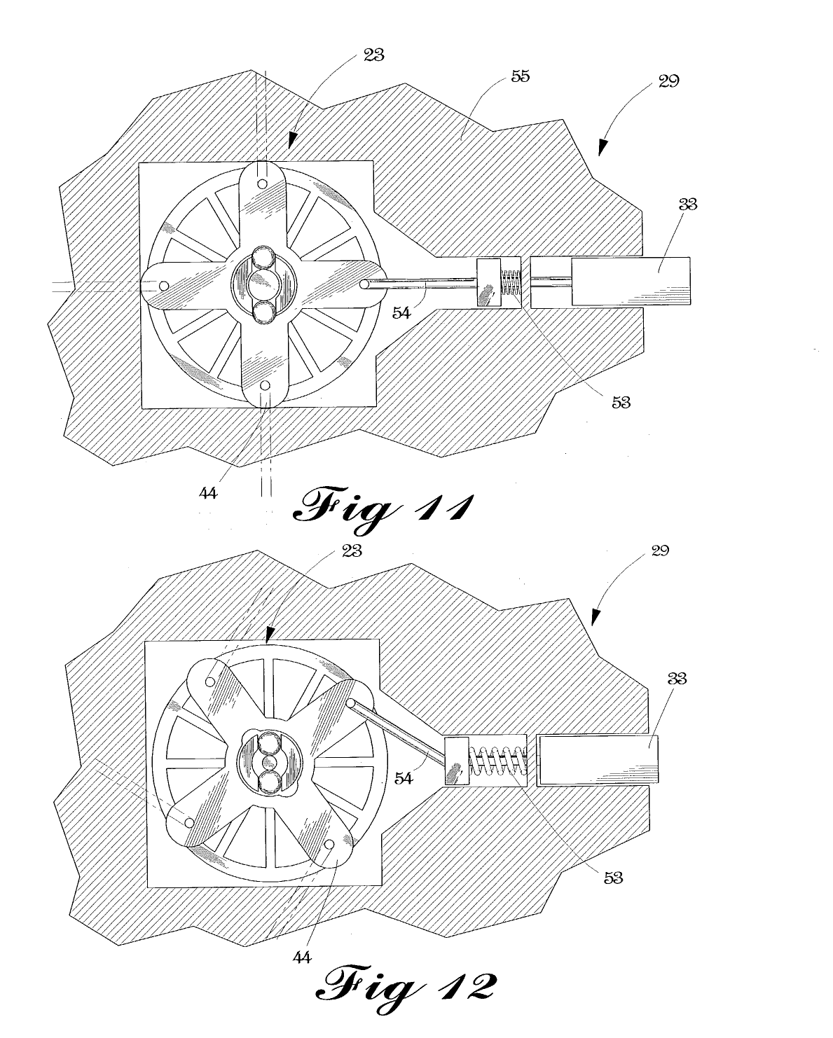

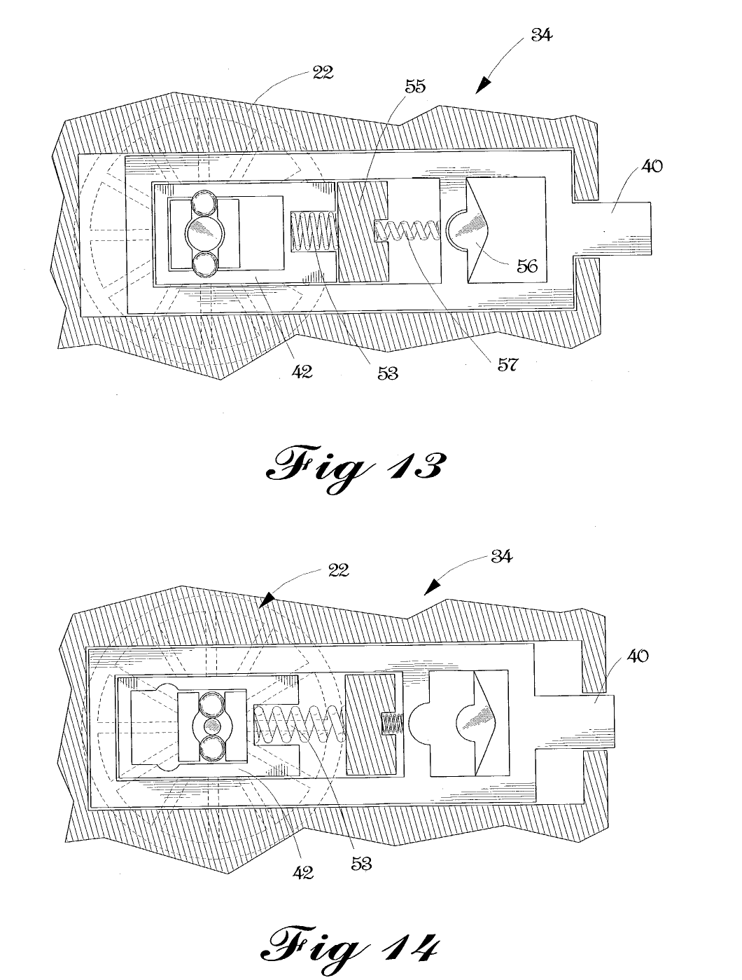

FIG. 12 shows the rotary/linear differential pressure sensing release system 29 of FIG. 11 in the activated position where the rotary differential pressure sensing mechanism 23 has released the rotary trigger link 44 that is rotated by the energy storage device 53 releasing its energy and thereby pushing the latch bolt 33 to an unlatched position.

FIG. 13 shows a linear differential pressure sensing release system 34 with a linear latching bolt 40 in the latched position with the linear differential pressure sensing mechanism 22 with its linear trigger link 42 holding an energy storage device 53 in the stored position against a latch housing boss 55. The latch bolt 40 is free to operate by a driver 56 and spring 57.

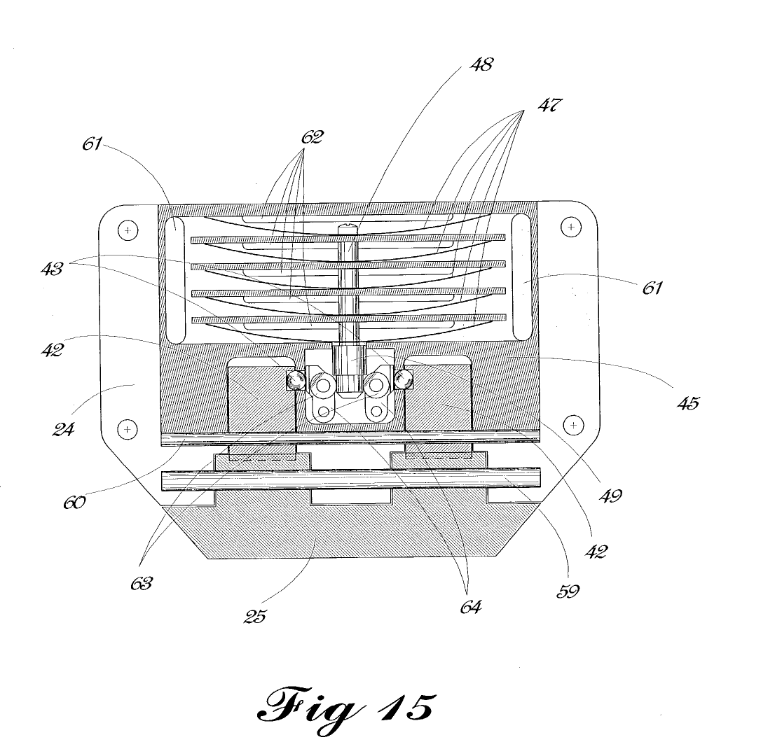

FIG. 14 shows the linear/linear differential pressure sensing release system 34 of FIG. 13 in the activated position where the linear differential pressure sensing mechanism 22 has released the linear trigger link 42 that is pushed back by the energy storage device 53 releasing its energy and thereby pushing the latch bolt 40 to an unlatched position

FIG. 15 shows the specific differential pressure sensing release apparatus 22 shown in FIG. 1 and is a composite mechanism of FIG. 4, FIG. 6, and FIG. 9 and includes features that enhance the operation of the apparatus. The apparatus comprises a latch housing 24 containing a bolt 25 rotating on a shaft 59 retained by two trigger links 42 rotating on a shaft 60. The trigger links 42 are retained by two detents 43 contained within a vented frame 45 and are retained by two bearing supports 64 that hold bearings 63. The bearings 63 and their supports 64 are retained by the escapement piston 49 and rod 48 which in turn are connected to multiple diaphragms 47 contained within the vented frame 45. Venting for the diaphragms 47 is accomplished by positive pressure vents 61 and negative pressure vents 62.

I claim:

1. A differential pressure sensing release system and apparatus particularly adapted for use in an aircraft compartment panel and the apparatus thereof comprising:
a. a housing configured to be fastened to the panel;
b. a differential pressure sensing mechanism contained within the housing that reacts in proportion to a pressure differential occurring on either side of the flight deck door and imparts a linear motion within the mechanism;
c. a release mechanism contained within the housing and operatively coupled to the differential pressure sensing mechanism that reacts to the imparted linear movement of the pressure sensing mechanism reacting to the pressure differential by removing the restraining action of the release mechanism;
d. a bolt member disposed within the housing and operatively coupled to the release mechanism in such a manner as to contain or otherwise restrain the compartment panel or a panel within the panel.

2. The apparatus of claim 1, wherein the differential pressure sensing mechanism comprising:
a. a vented frame
b. a diaphragm disposed within a frame;
c. an escapement piston and rod disposed within the vented frame, coupled to the diaphragm;
d. a detent(s) disposed within the frame, actuated by imparted movement of the escapement piston and rod.

3. The apparatus of claim 2, wherein the diaphragm comprises a thin non-metallic disk surrounding a thin metallic disk of lesser diameter.

4. The apparatus of claim 2, wherein the diaphragm comprises a thin metallic rectangle.

5. The apparatus of claim 1, wherein the release mechanism comprises a linear trigger link.

6. The apparatus of claim 1, wherein the release mechanism comprises a rotary trigger link.

7. The apparatus of claim 1, wherein the bolt comprises a rotary, self energizing member attached to the housing with a shaft.

8. The apparatus of claim 1, wherein the bolt comprises a linear, spring energized member operatively coupled to the trigger link.

9. A differential pressure sensing release system and apparatus particularly adapted for use in an aircraft compartment panel and the apparatus thereof comprising:
a. a housing configured to be fastened to the panel;
b. a differential pressure sensing mechanism contained within the housing that reacts in proportion to a pressure differential occurring on either side of the flight deck door and imparts a linear motion within the mechanism and is specifically oriented so the imparted linear motion is 90 degrees to movement direction of the panel;
c. a release mechanism contained within the housing and operatively coupled to the differential pressure sensing mechanism that reacts to the imparted linear movement of the pressure sensing mechanism reacting to the pressure differential by removing the restraining action of the release mechanism;
d. a bolt member disposed within the housing and operatively coupled to the release mechanism in such a manner as to contain or otherwise restrain the compartment panel or a panel within the panel.

10. The apparatus of claim 9, wherein the differential pressure sensing mechanism comprising:
a. a vented frame
b. multiple diaphragms disposed within a frame;
c. an escapement piston and rod disposed within the vented frame, coupled to the diaphragm;
d. a detent(s) disposed within the frame, actuated by the imparted movement of the escapement piston and rod
e. a bearing(s) and support disposed within the frame, actuated by the movement of the detent(s)

11. The apparatus of claim 10, wherein the diaphragms comprises a thin metallic rectangles.

12. The apparatus of claim 9, wherein the bolt comprises a rotary, self energizing member attached to the housing with a shaft.

13. The apparatus of claim 9, wherein the release mechanism comprises a rotary trigger link.
